(19) United States
(12) Patent Application Publication
(10) Pub. No.: US 2012/0085055 A1
(43) Pub. Date: Apr. 12, 2012

(54) GROUTLESS TILE SYSTEM AND METHOD FOR MAKING THE SAME

(75) Inventors: David Earl, Dallas, TX (US); Tom Alford, Rockwall, TX (US); Rahul Patki, Dallas, TX (US); Wesley King, Rockwall, TX (US); Mark Cappelle, Staten (BE)

(73) Assignee: Mohawk Carpet Corporation, Calhoun, GA (US)

(21) Appl. No.: 13/328,328

(22) Filed: Dec. 16, 2011

Related U.S. Application Data
(63) Continuation-in-part of application No. 13/186,989, filed on Jul. 20, 2011.
Application No. 13/186,989 is a division of application No. 11/701,777, filed on Feb. 2, 2007, now Pat. No. 7,984,600.

(51) Int. Cl. E04C 2/38; B29C 45/14; E04C 2/20

(52) U.S. Cl. 52/309.1; 52/588.1; 264/46.4

(57) ABSTRACT

A groutless tile system including groutless tiles, wherein each groutless tile includes a substrate, a durable surface disposed within a groove defined by the substrate, the durable surface having bottom surface, and a first coupling member disposed on an edge of the substrate. The first coupling member comprises a first bendable portion and a groove, the groove having an upper surface and a lower surface. The bottom surface of the durable surface is substantially coplanar with a point between the upper and lower surfaces of the groove. The polymer matrix forming at least a portion of the substrate can be modified to reduce the weight of the groutless tile or the cost to manufacture the groutless tile. In some embodiments, the polymer matrix is modified through the use of gas nucleation or a blowing agent.

### CROSS-REFERENCE TO RELATED APPLICATION & PRIORITY CLAIM

This application is a continuation-in-part of U.S. patent application Ser. No. 13/186,989, filed Jul. 20, 2011, and entitled “Groutless Tile System And Method For Making The Same,” which is a divisional of U.S. patent application Ser. No. 11/701,777, filed Feb. 2, 2007, and entitled “Groutless Tile System And Method For Making The Same,” which are incorporated herein by reference in their entirety as if fully set forth below.

### BACKGROUND OF THE INVENTION

1. Field of the Invention

The present invention relates generally to floor and wall covering tiles. More particularly, it relates to a tile system that does not require a grout compound to be applied to the tiles after installation.

2. Description of Related Art

Ceramic tiles are widely used as a floor and wall covering in both residential and commercial applications. Tile is very versatile, and has been in use as a floor and wall covering for centuries. Tiles are available in a nearly unlimited color palette and may be installed in an equally unlimited number of designs. Tile is often a top choice for floor and wall coverings because of its great durability and aesthetic qualities. While many tiles are manufactured from ceramic compositions (baked clay), they may be made of a variety of natural or synthetic materials including, but not limited to, granite, quartz, marble, soapstone, plastic, wood, or a other suitable material.

Tile provides a durable surface and may be coated to be substantially impervious to water and other liquids. When tiles are installed, they are generally laid side by side on a surface such as a floor or wall. Typically, an adhesive compound is used as a base to attach the tiles to a surface and then grout is spread over and between the tiles to further bind the tiles to the surface and to fill spaces between adjacent tiles. While not impervious to water and moisture, the grout provides a barrier to reduce moisture between and behind the tiles. This step of grouting the tiles is labor intensive and represents a significant portion of the labor involved in a typical tile installation.

Due to the time and labor involved in tile installation, it is typically quite costly to have tile professionally installed. Accordingly, many homeowners desire to install tile in their own homes. Unfortunately, this is an extremely tedious process, and many homeowners do not wish to spend the time necessary for a satisfactory installation.

In recent years, manufacturers have attempted to produce do-it-yourself tile solutions that are easier to install. One such attempt is described in United States Publication Number US 2004/0031226 entitled “Pre-glued Tongue and Groove Flooring” by Miller et al. Disclosed therein is a laminated “tile” that uses a pre-applied glue for fastening the tiles together. While this system is easier to install than traditional tiles, it still requires a separate grout to be applied and uses a laminate material rather than a solid tile. A laminate material is not likely to be as durable as more traditional materials such as ceramic or stone tiles. Additionally, because the tile system makes use of a laminated structure that is susceptible to moisture damage, the installer is required to apply a messy grout composition or sealant to the joints between the tiles as part of the installation process to protect the laminate from moisture damage.

A previous attempt to produce an easy to install tile is described in U.S. Pat. No. 2,693,102 entitled “Interlocking Wall Tile.” The '102 patent describes a synthetic wall tile system that snaps together. Unfortunately, this tile is not practicable with substantially ridged materials, such as ceramic, granite, or marble. The Luster et al. tiles are molded into a uniform structure of a single material and rigid materials could not be formed into an operable tab structure as taught in the patent. Such a limitation severely limits the aesthetic qualities available for the tiles and thereby reduces the marketability of the system.

Accordingly, there is a need in the art for a tile system that is simple to install.

Additionally, there is a need in the art for a tile system that does not require a grout to be applied to the tiles after installation.

Further, there is a need in the art for an easy to install tile system that makes use of durable tile materials.

In addition, there is a need in the art for a tile system that primarily utilizes traditional tile materials, but eliminates the need for grout.

### BRIEF SUMMARY OF THE INVENTION

Briefly, described herein is a tile having at least one coupling member that cooperatively engages a coupling member of an adjacent tile, such that adjacent tiles can be reasonably secured to one another without the use of grout. In one exemplary embodiment, cooperative coupling members are a male-type coupling members and female-type coupling members that are designed to secure adjacent tiles.

In exemplary embodiments, a wide variety of tiling systems may be used. For example, in one exemplary tiling system individual tiles may include all male-type or all female-type coupling members. In another example, the individual tiles may include two male-type coupling members and two female-type coupling members located on either adjacent or opposing edges of the tiles. In yet another example, the individual tiles may have another combination of male-type and female-type coupling members disposed on one or more of the edges of the tiles. The above examples are only intended as illustrations and are not intended to be limiting in any way; on the contrary, a wide variety of alternative exemplary embodiments would be understood to a person of ordinary skill in the art.

Disclosed herein is a groutless tile system including: a plurality of groutless tiles, wherein each groutless tile includes: a durable surface disposed on a substrate; a first coupling member disposed on an edge of the substrate; and a second coupling member disposed on an opposing edge of the substrate, wherein at least a portion of the substrate extends beyond the durable surface, wherein the first coupling member and the second coupling member of the groutless tiles are operable for coupling adjacent groutless tiles, and wherein the substrate maintains spacing between the durable surfaces of adjacent groutless tiles.

Also disclosed herein is a groutless tile including: a durable surface disposed on a substrate; a first coupling member disposed on an edge of the substrate; and a second coupling member disposed on an opposing edge of the substrate, wherein the first coupling member and the second coupling member of the substrate extend beyond the durable surface, wherein the first coupling member and the second coupling member of the groutless tile are operable for coupling the groutless tile to an adjacent groutless tile, and wherein at least a portion of the substrate extends vertically to form a substantially continuous surface with the durable surface.

Further disclosed herein is a method for making a groutless tile including: providing a durable surface; molding a substrate to receive at least a portion of the durable surface; affixing the durable surface to the substrate; and milling at least a portion of the substrate to create a first coupling member on an edge of the substrate and a second coupling member on a opposing edge of the substrate.

Still further disclosed herein is a floor covering consisting of floor elements including at least a synthetic support structure and a decorative element selected from the group consisting of natural stone, terracotta, ceramic tile and synthetic stone; the decorative element being supported, either directly or indirectly, by the support structure and at least partially defining the upper side of the floor element; the support structure at least at a first pair of two opposite sides including coupling parts, which are realized substantially as a male coupling part and a female coupling part, which are provided with vertically active locking portions, which, when the coupling parts of two of such floor elements cooperate with each other, effect a locking in a vertical direction and also are provided with horizontally active locking portions, which, when the coupling parts of two of such floor elements cooperate with each other, effect a locking in horizontal direction whereby the coupling parts are of the type allowing that two of such floor elements can be connected to each other at the sides by engaging one of these floor elements with the associated male coupling part, by means of a rotational and/or planar motion, in the female coupling part of the other floor element; wherein the male coupling part projects at least partially beyond the upper edge of the concerned side. In a preferred embodiment said horizontally active locking portion, in a coupled condition of two such floor elements or tiles, is located vertically under a durable surface of at least one of said tiles. Said durable surface is preferably formed by said decorative element. In another or the same preferred embodiment said vertically active locking portions can substantially have the shape of a tongue and a groove, which in a coupled condition of two of such floor elements or tiles, preferably, wholly or partially, engage vertically under a portion of the synthetic support structure or substrate, whereby this portion of the substrate extends horizontally beyond said durable surface or said decorative element of at least one of said tiles. It is possible that contact surfaces are formed between the tongue and the groove, said contact surfaces preventing or limiting vertical motion of two tiles or floor elements in a coupled condition thereof. At least one of said contact surfaces, being located at the top side of the tongue, is preferably located in a plane, e.g. a horizontal plane, which intersects the decorative element forming said durable surface. Instead of being located in a plane, the concerned contact surface might also show a point of contact which is located the closest to the durable surface and which is located in a horizontal plane which intersects the decorative element forming said durable surface.

Also disclosed herein is a method for manufacturing floor elements including at least a synthetic support structure and a decorative element selected from the group consisting of natural stone, terracotta, ceramic tile and synthetic stone; the decorative element being supported, either directly or indirectly, by the support structure and at least partially defining the upper side of the floor element; the support structure having edge portions; the edge portions at least at two opposite sides of the support structure having coupling parts; wherein the method at least includes the following two successive steps: the step of providing a semi-finished product including at least the aforementioned support structure and the aforementioned decorative element; the step of performing a machining treatment on at least an edge portion of the already formed semi-finished product, more particularly on the edge portions of the support structure of the semi-finished product, in order to manufacture at least part of the coupling parts to be formed therein.

Additionally disclosed herein is a composite groutless tile with improved mechanical properties and/or performance benefits when compared to conventional ceramic tile. In some embodiments, the composite groutless tile used in a groutless tile system comprises a ceramic tile encapsulated in a polymer, wherein at least a portion of the polymer can be removed, e.g. milled, to produce a tongue and groove interlocking profile for use in the groutless tile system. In an embodiment, the polymer is disposed directly on a surface of the tile.

Further disclosed herein is a groutless tile using a substrate with a modified polymer matrix. The modified polymer matrix comprises a first polymer and comprises a lower amount of the first polymer per unit volume of substrate than an unmodified polymer matrix. The amount of modified polymer matrix can be reduced by about 10 to about 40%, about 20 to about 35% or about 25% to about 35%. The groutless tile further comprises a durable surface disposed on the substrate. The modification of the polymer matrix can reduce the weight and/or cost of the groutless tile. In one exemplary embodiment, the polymer matrix comprises a second polymer of lower weight or cost than the first polymer. In a further exemplary embodiment, the modified polymer matrix is modified by the process of gas nucleation. In a still further exemplary embodiment, the modified polymer matrix is modified by a blowing agent.

Disclosed herein is also a method of manufacturing a groutless tile system comprising providing a durable surface, inserting and positioning the durable surface into a mold, forming a substrate comprising a first polymer and a second component around at least a portion of the durable surface to create a groutless tile, wherein the second component reduces the amount of the first polymer per unit volume of substrate, wherein at least a portion of the substrate extends beyond the durable surface, and producing a first coupling member and a second coupling member by removing at least a portion of the substrate material, wherein the first coupling member comprises a first bendable portion and a groove. In some exemplary embodiments, forming the substrate comprises injection molding or reaction injection molding. In further exemplary embodiments, the second component is a blowing agent or an inert gas. In still further exemplary embodiments, the second component, which is comprised of a pre-formed or shaped solid component, comprises at least a portion of the substrate.

Still further disclosed herein is a groutless tile system, comprising a plurality of groutless tiles, wherein each groutless tile comprises a substrate comprised of a polymer matrix comprising a first polymer, wherein the polymer matrix is modified to reduce the amount of first polymer used for unit volume of the polymer matrix, a durable surface disposed within a groove defined by the substrate, a first coupling member disposed on an edge of the substrate, wherein the first coupling member comprises a first bendable portion and a groove, wherein at least a portion of the substrate extends beyond the durable surface, wherein the first coupling member and a second coupling member of an adjacent groutless tile comprising a tongue and a body portion are operable for coupling adjacent groutless tiles, wherein the tongue is located at a distal end of the second coupling member and extends outwardly and substantially horizontally from an edge of a substrate of the adjacent groutless tile, wherein the groove of the first coupling member is configured to receive the body portion and the tongue of the second coupling member, wherein, upon coupling the adjacent tiles, the tongue and the groove engage under the portion of the substrate that extends beyond the durable surface, wherein, upon coupling of the adjacent tiles, a gap remains between a distal end of the tongue and a proximal end of the groove, wherein, upon coupling of the adjacent tiles, a contact surface between the tongue and the groove is formed at a top side of the tongue, such that the contact surface limits vertical motion of the coupled adjacent tiles, and wherein at least a portion of the first bendable portion is disposed below the durable surface of the adjacent tile when coupled to the adjacent tile.

These and other objects, features and advantages of the present invention will become more apparent upon reading the following specification in conjunction with the accompanying drawing figures.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective view illustration of a tile in accordance with an exemplary embodiment of the present invention;

FIG. 2 is a cross-sectional view illustration of another tile in accordance with an exemplary embodiment of the present invention;

FIG. 3 is a cross-sectional view illustration of two adjacent tiles in accordance with an exemplary embodiment of the present invention; and

FIG. 4 is an illustration of a method for making a tile in accordance with an exemplary embodiment of the present invention.

FIG. 5 is a cross-sectional micrograph of an unmodified polymer matrix of a groutless tile in accordance with an exemplary embodiment of the present invention.

FIGS. 6a and 6b are cross-sectional micrographs of a polymer matrix of a groutless tile modified by gas nucleation in accordance with an exemplary embodiment of the present invention.

FIGS. 7a, 7b, and 7c are cross-sectional micrographs of a polymer matrix of a groutless tile modified by a blowing agent in accordance with an exemplary embodiment of the present invention.

FIG. 8 is a graph of tile properties versus reduction level in accordance with an exemplary embodiment of the present invention.

FIG. 9a is a cross-sectional view illustration of an encapsulated composite groutless tile in accordance with an exemplary embodiment of the present invention.

FIG. 9b is a cross-sectional view illustration of a fully encapsulated side surface of a composite groutless tile in accordance with an exemplary embodiment of the present invention.

FIG. 10 is a cross-sectional view illustration of a fully encapsulated composite groutless tile in accordance with an exemplary embodiment of the present invention.

The detailed description explains the preferred embodiments of the invention, together with advantages and features, by way of example with reference to the drawings.

### DETAILED DESCRIPTION OF THE INVENTION

As used herein, the term “disposed” generally means located either at or upon. Additionally, the term disposed is intended to include an element integrally or detachably connected to another element as well as object simple placed on another element. Furthermore, it will be understood that when an element is referred to as being “disposed on” another element, it can be directly on the other element or intervening elements may be present there between. In contrast, when an element is referred to as being “disposed directly on” another element, there are no intervening elements present.

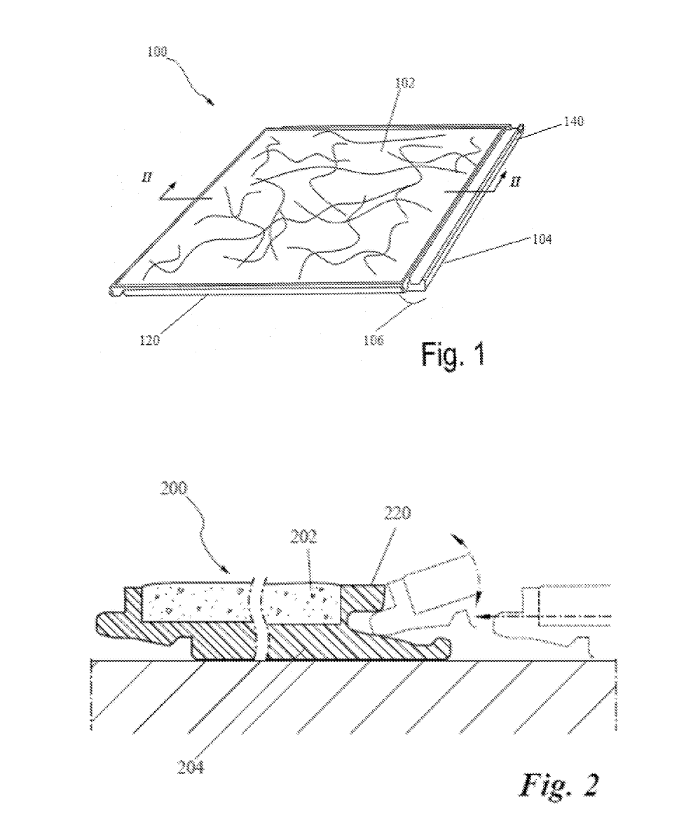

Referring now to FIG. 1, a groutless tile in accordance with an exemplary embodiment of the present invention is generally depicted as 100. The groutless tile 100 includes a durable surface 102 that is disposed on a substrate 104. In exemplary embodiments, the durable surface 102 may be affixed to the substrate 104 using a wide variety of methods such as the use of an adhesive. The durable surface 102 may be a ceramic composition (baked clay), or it may be made of a variety of natural or synthetic materials including, but not limited to, granite, quartz, marble, soapstone, plastic, wood, or another suitable material. Likewise, the substrate 104 may be a made of a suitable polymeric material. In exemplary embodiments, the substrate 104 may be constructed of a suitable material that is chemical resistant, stain resistant, non-porous, and formable to within sufficient precision. While the groutless tile 100 is depicted in a square shape, it will be clear that alternate shape groutless tiles such as hexagon, octagon, or the like are also contemplated.

In exemplary embodiments, the substrate 104 is designed to have larger dimensions than the durable surface 102 such that the durable surface 102 may be disposed within a groove defined by the substrate 104. In one embodiment, the top surface of the durable surface 102 and the top surface of the substrate 104 may form a continuous surface. The substrate 104 includes a flange portion 106 that is disposed along the edges of the substrate 104. The flange portion 106 further includes a first coupling member 120 and a second coupling member 140, which may be disposed on opposing or adjacent sides of the groutless tile 100. The first coupling member 120 and the second coupling member 140 are designed such that they are operable for coupling together one or more adjacent groutless tiles 100.

In exemplary embodiments, the groutless tile 100 may include an underlayment layer that may act as a moisture or sound barrier. Additionally, the underlayment may serve a surface leveling function. Further, the underlayment may serve as an adhesive for attaching the tiles to an installation surface, such as a floor or a wall. The composition of the underlayment layer may depend upon the intended purpose of the underlayment layer. In exemplary embodiments, the underlayment layer may be a multilayered layment composed of several distinct layers each designed to perform a specific function. The underlayment may be secured to substrate 104 of the groutless tile 100 through the use of an adhesive or another suitable means.

In an exemplary embodiment, at least a portion of the flange portion 106, may be of polymeric material and preferably is a polyurethane material, such as ELASTOCASTr70654 by BASF®. ELASTOCASTr70654 is an unpigmented, 77 to 79 Shore D urethane elastomer designed for cross-sections up to three inches, which has some inherent tackiness. It is also contemplated that another polymeric material may be used in flange portion 106. The following data may be helpful in producing the material used in a flange portion 106 in accordance with an exemplary embodiment. This data is provided for example only in Table 1, below, and is not intended to limit the scope of the invention. Other compositions may also be used to fabricate the flange portion 106.

TABLE 1

| Mix Ratio @ | 100 parts of ELASTOCASTr70654 Resin | |
|---|---|---|
| 105 index: | 771. parts of WUC 3192T ISOCYANATE | |
| Specific Gravity: | Resin | 1.048 g/cc, 8.72 lbs./gal. @ 77° F. |
| | Iso | 1.22 g/cc, 10.2 lbs./gal. @ 77° F. |
| Viscosity: | Resin | 1220 cps @ 77° F. |
| | Iso | 200 cps @ 77° F. |

| Typical Reactivity: | Hand mixed at 86° F. at 105 index | |
|---|---|---|
| | Gel time: 180 to 240 seconds | |
| Recommended | Component temperatures: | Resin 75-95° F. |
| processing | | Iso 75-95° F. |
| conditions: | Mold temperature: | 130-160° F. |
| | Demold time: | 10-20 minutes |

Alternatively, other polymer variations can include thermoplastic polymers and thermoset polymers, including for example polyamides, vinyl polymers and polyolefins. Preferably, the flange portion 106 may be made, but is not so limited, from a material that is chemical resistant, stain resistant, non-porous, and formable to within sufficient precision. Additionally, it may be desirable for the flange portion 106 to have sealing qualities so as to impede the intrusion of moisture between and behind the tiles and adherence qualities so as to minimize or present movement or displacement of the tiles.

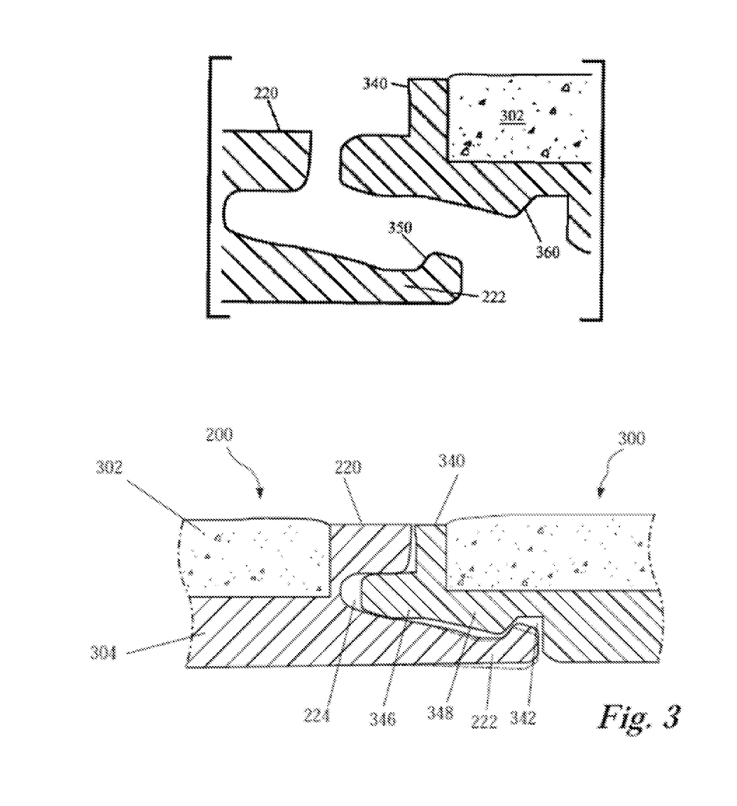

Turning now to FIGS. 2-3 which illustrate the coupling of a first groutless tile 200 with a second groutless tile 300. A first coupling member 220 and a second coupling member 340 function to connect the first groutless tile 200 and the second groutless tile 300. The first coupling member 220 of the first groutless tile 200 includes a first bendable portion 222 and a groove 224. The second coupling member 340 of the second groutless tile 300 includes a tongue 346 and a body portion 348. The groove 224 of the first coupling member 220 is designed to receive the body portion 348 and the tongue 346 of the second coupling member 340. Once positioned inside the groove 224 of the first coupling member 220 the body portion 348 and the tongue 346 contacts the first bendable portion 222 and the groove 224, respectively. In one embodiment, the tongue 346 and the first bendable portion 222 are designed to bend at least the first bendable portion during the coupling of the groutless tile 200 and the second groutless tile 300. Additionally, the tongue 346 and the first bendable portion 222 are designed such that at least the first bendable portion 222 returns to or towards its normal unbent position once the groutless tile 200 and the second groutless tile 300 are coupled in order to prevent the tiles from separating. A contact surface between said tongue 346 and said groove 224 is also formed at the top side of said tongue 346, whereby said contact surface is located in a horizontal plane, which intersects the decorative element forming said durable surface 102. In another embodiment, the contact surface can be located in a horizontal plane that does not intersect with the decorative element, e.g the bottom of the tile.

Continuing with reference to FIG. 3, the first bendable portion 222 includes an enlarged portion on its distal end that has an inclined inner surface 350. Additionally, the body portion 348 of the second coupling member 340 also includes an inclined surface 360 on its proximal end. The inclined inner surface of the first bendable portion 222 is designed to have a substantially complimentary angle to that body portion 348 of the second coupling member 340. The first bendable portion 222 is designed to slideably contact the body portion 348 during the coupling of the groutless tile 200 and the second groutless tile 300. Furthermore, the inclined surfaces of the first bendable portion 222 and body portion 348 are operable for properly positioning and the groutless tile 200 and the second groutless tile 300 during coupling. In exemplary embodiments, the inclined surfaces of the first bendable portion 222 and the body portion 348 function to keep the groutless tile 200 and the second groutless tile 300 properly positioned while the tiles are coupled to one another. Said inclined inner surfaces of both said body portion 348 and said enlarged portion 342 form horizontally active locking portions, which in a coupled condition are located vertically under a durable surface 202, 302 of at least one of said tiles 200-300.

In exemplary embodiments, the tongue 346 is located at the distal end of the second coupling member 340 and extends substantially horizontally and outwardly from the second groutless tile 300. Said tongue 346 of said second coupling member 340 and said groove 224 of the first coupling member 220 are vertically active locking portions and wholly engage vertically under a portion of the synthetic support structure or substrate 204, 304, whereby this portion of the substrate 104 extends horizontally beyond said durable surface 202, 302 of said decorative element of at least one of said tiles 200-300.

In exemplary embodiments, the first groutless tile 200 may be coupled to the second groutless tile 300 by snapping or pushing the second coupling member 340 of the second groutless tile 300 into the first coupling member 220. In one embodiment, a lateral or horizontal motion is necessary to properly couple the first groutless tile 200 and the second groutless tile 300. Furthermore, during the coupling of the groutless tile 200 and the second groutless tile 300 the second coupling member 340 of the second groutless tile 300 may be locked into position once inserted into the groove 224 of the first coupling member 220. Additionally, during the coupling of the first groutless tile 200 and the second groutless tile 300 the first bendable portion 222 may be bent to accommodate the insertion of the first body portion 348 into the groove 224. After the first groutless tile 200 and the second groutless tile 300 are coupled the first bendable portion 222 returns to or towards its normal unbent position and remains in contact with the body portion 348. In exemplary embodiments, the first groutless tile 200 and the second groutless tile 300 may be separated from one another by pivotally disengaging the first groutless tile 200 from the second groutless tile 300, preferably without damaging the respective tiles and their coupling members. It is noted that in a completely coupled condition of the respective groutless tiles 200-300, it is possible that the first bendable portion 222 is bent out of the level under surface of said tiles 200-300. Such bending out might create an extra firm coupling especially in the horizontal direction, thereby strongly preventing separation of two coupled tiles in said horizontal direction.

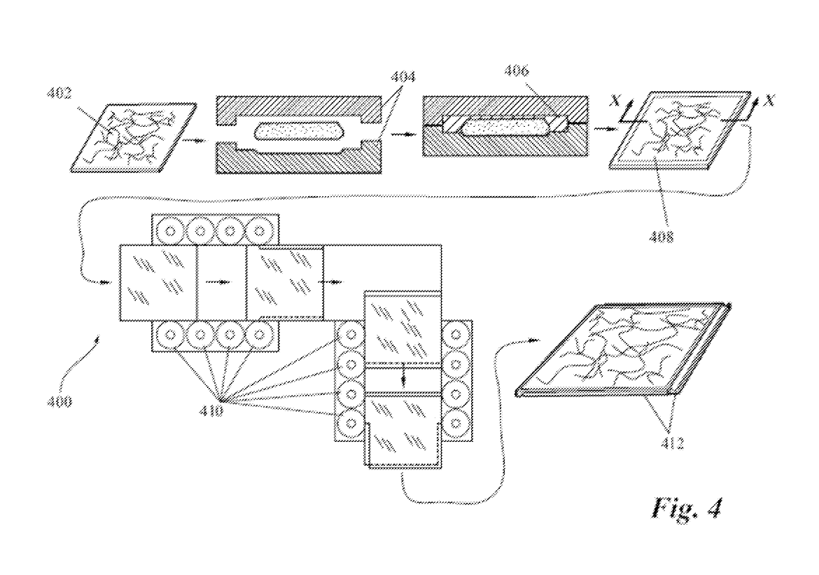

Turning now to FIG. 4, an illustration of a method for making a tile in accordance with an exemplary embodiment of the present invention is generally depicted as 400. During the first step in the method 400, a durable surface 402 is provided and inserted into a mold 404. Once the durable surface 402 has been positioned in the mold 404 a substrate 406 may be formed around a portion of the durable surface 402. In one embodiment, the substrate 406 may be a plastic material that is injection molded or reaction injection molded (RIM) around the durable surface 402. The substrate 406 forms around the durable surface 402 to create the groutless tile 408. Next the groutless tile 408 is processed through a series of tools 410 that are used to create one or more flanges 412 around the edges of the tile 408. In one embodiment, the tools 410 may perform a milling process with one or more milling cutters that are positioned at different positions and angles with respect to the groutless tile 408. As shown in FIG. 4, the flanges 412 including the first and second coupling members may extend the entire length of one side of the substrate 406 thereby simplifying the milling process.

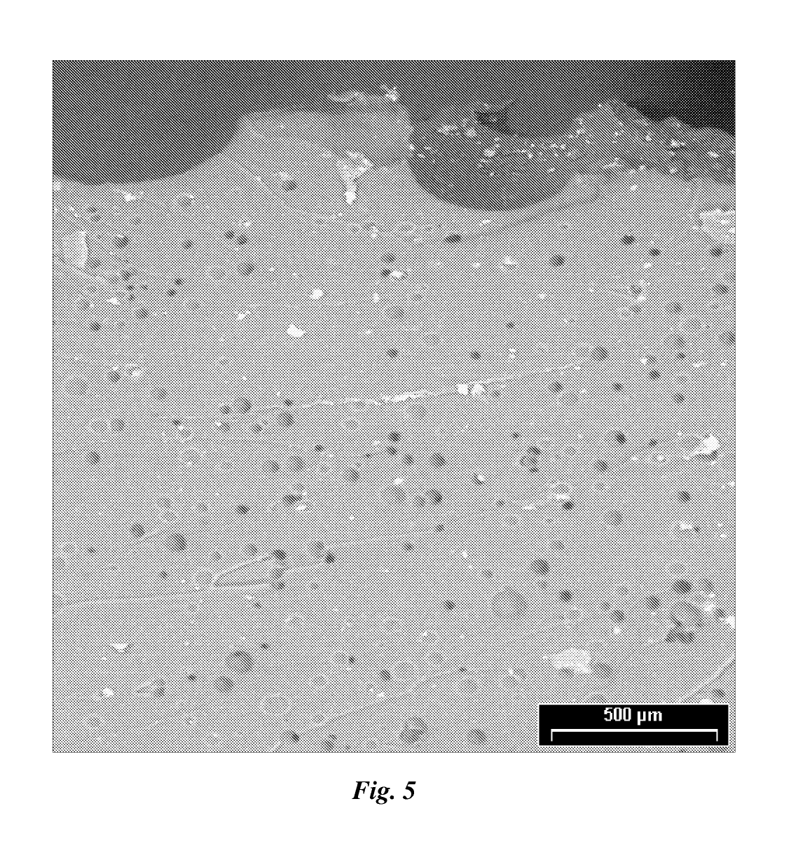

Various methods and materials can be used to reduce manufacturing costs associated with groutless tiles produced in accordance with various embodiments of the present invention. In some embodiments, a large percentage of the total manufacturing cost can be material costs. When using polymers, a large percentage of the material cost of groutless tiles of the present invention can be the polymeric material component itself, e.g. polyurethane in some embodiments. In some embodiments, the polyurethane used is a full-density polyurethane, i.e. a dense polymer matrix, and can account for approximately seventy-five percent (75%) of the total cost of raw materials, or higher, depending on the selection of the other raw materials. In addition to the associated costs, the full-density polyurethane contributes significantly to the overall weight of the groutless tile, making the tile difficult to handle depending on the installer. The total cost to manufacture and distribute the groutless tile is also influenced by the overall weight, and the full-density polyurethane contributes significant weight for the product. FIG. 5 is a cross-section micrograph showing the closed-cell polymer microstructure of a groutless tile substrate made using conventional full-density polyurethane. The conventional full-density polyurethane shown in FIG. 5 exhibits a fairly uniform and consistent structure. The small number of voids or bubbles seen is normal for a conventional RIM polyurethane process.

Exemplary embodiments of the present invention can utilize methods and/or components in the manufacturing process to modify a polymer matrix, to reduce the amount of polymeric component used per unit volume of the polymer matrix which forms at least a portion of the substrate. The unit volume can be defined as the volume of material for a given polymer matrix. The modification can reduce the weight and/or cost of polymeric-based groutless tiles. Thus, a modified polymer matrix can be of lower cost or weight, or both, than an unmodified polymer matrix comprising one polymer. One of ordinary skill in the art would understand that the reduction can be characterized as a change in the amount of material in the polymer matrix. In one embodiment, the reduction can be described by a density change. In another embodiment, the reduction can be described by a weight change, because the weight of the material in a unit of polymer matrix will change for that fixed unit of polymer matrix.

In one exemplary embodiment, a first polymer can be mixed with one or more second polymers, or other non-polymeric materials, having lower cost and/or weight in comparison to the polyurethane. As a non-limiting example, a second polymeric material could be polystyrene bead or other polymeric beads, or a nonpolymeric material, such as for example glass beads or other filler materials.

In accordance with an exemplary embodiment of the present invention, the amount of the first polymer used in a groutless tile can also be reduced by reducing the density of the first polymer, reducing the amount of polymer needed to manufacture a tile as well as the weight of the produced groutless tile. In various embodiments of the present invention, the density of an unmodified polymer matrix can be modified to produce a modified polymer matrix by using various methods, including, but not limited to, the addition of lower-density materials, gas nucleation, and blowing agents. Additionally, those of skill in the art will appreciate that there are other similar methods to modify the polymeric matrix to reduce manufacturing costs and/or the overall weight of the groutless tile.

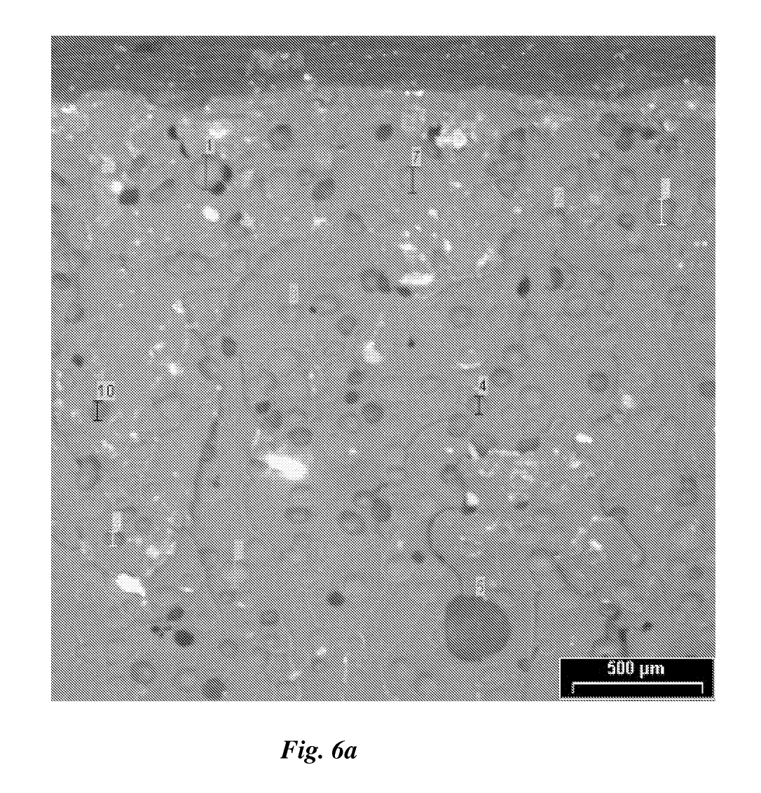

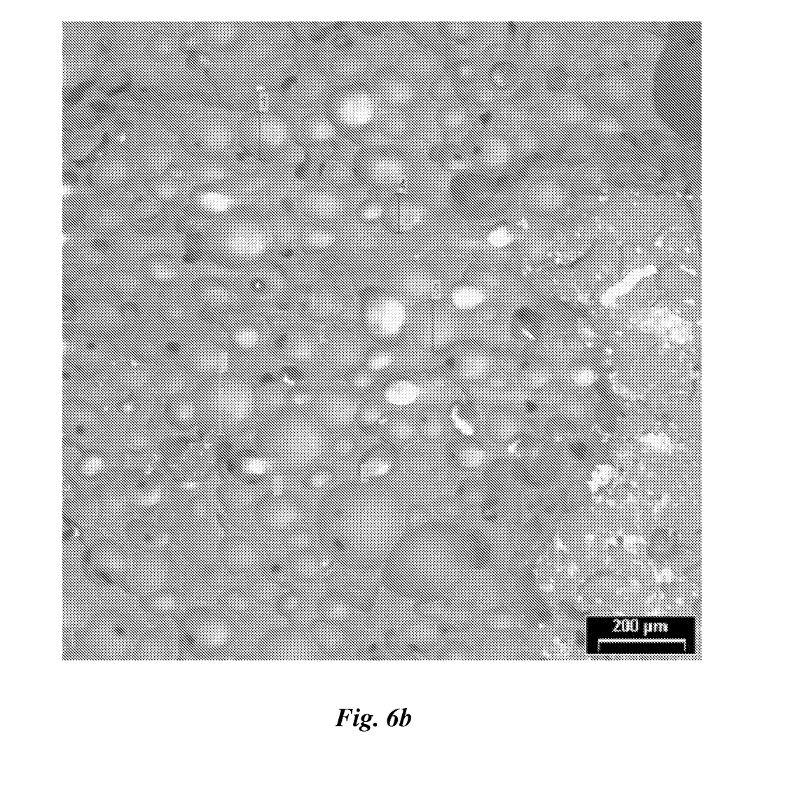

FIGS. 6a and 6b are cross-section micrographs showing exemplary embodiments of the closed cell polymer microstructures obtained in a given polyurethane polymer matrix that has been nucleated to the levels of 10% and 30% weight reduction. In one embodiment, gas nucleation is used to introduce gas bubbles into a polymer matrix to create the modified polymer matrix. Typically an inert gas such as nitrogen, carbon dioxide, or argon is physically mixed and partially dissolved into the polyol component of polyurethane. In an exemplary embodiment, the gas-filled polyol and the isocyanate components of polyurethane are mixed together at high pressure and injected or poured into a mold cavity containing a ceramic tile, e.g. a durable surface. As the pressure exerted on the dissolved gas drops from the mixing stage to the pouring stage, the gas bubbles form and/or expand within the polymer matrix, thereby displacing a certain volume of the mix while the mix fills the mold. This results in a modified polymer matrix having a lower density and/or weight than what would normally be seen in a non-nucleated, unmodified polymer matrix, such as the one shown in FIG. 5. The expanding gas bubbles create a closed-cell microstructure (a.k.a. microcellular), which is locked into the polymer matrix as the two components react and harden upon cure, creating a modified polymer matrix.

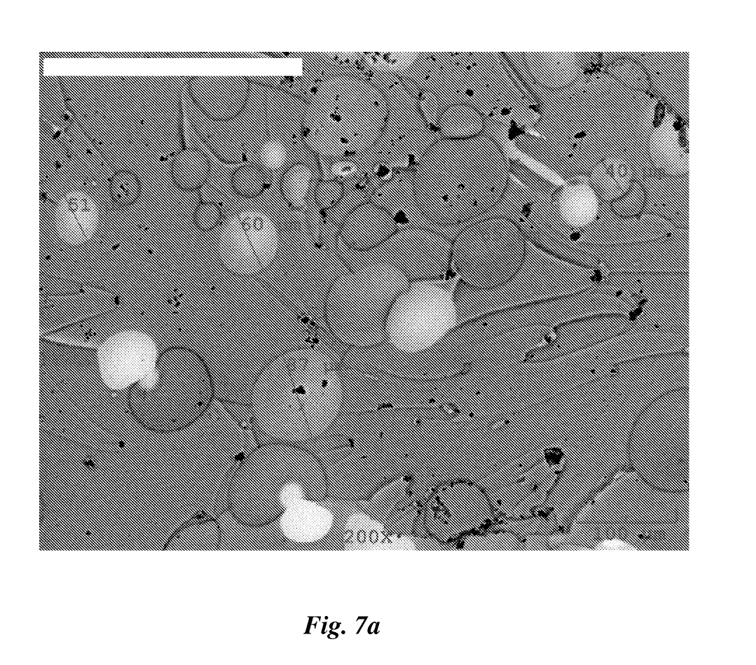

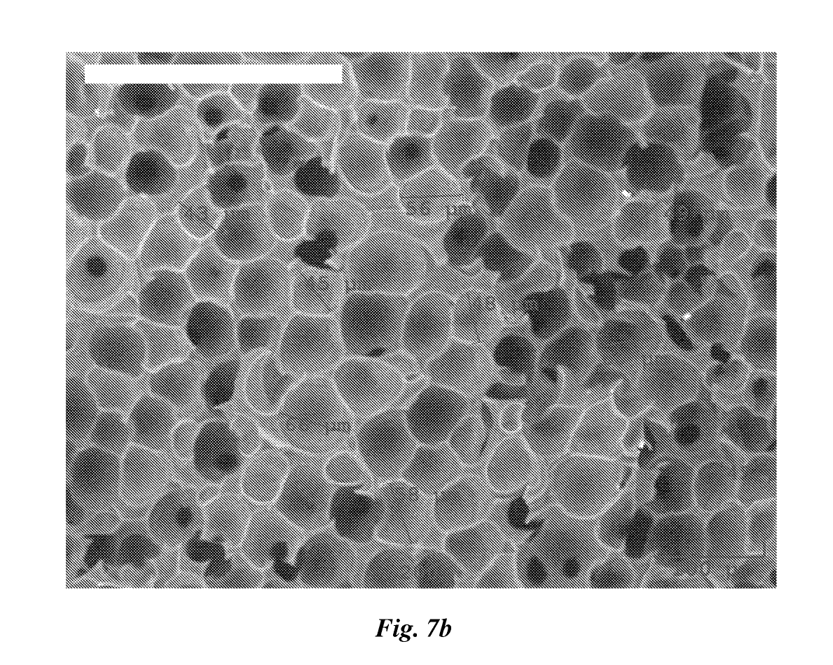

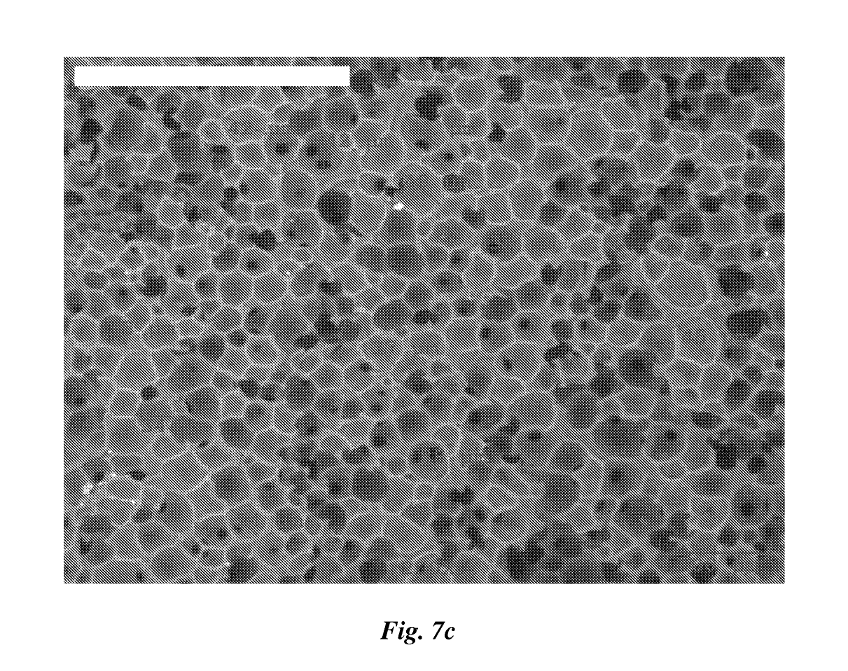

Another method for reducing the polyurethane polymer matrix density and forming a microcellular structure can involve the use of blowing agents, which can be physical or chemical in nature. In these exemplary embodiments, a physical blowing agent, defined as a low boiling or subliming chemical, can be blended into a component of the polyurethane, e.g. the polyol or the isocyanate. Some examples of physical blowing agents include, but are not limited to, halogenated hydrocarbons such as, for example, hydrofluorocarbons, hydrochlorofluorocarbons and the like, hydrazines, carbonates, azodiocarbonamide, and/or other nitrogen-based materials. The reaction between the polyol component and isocyanate components in polyurethane is exothermic in nature. The heat from the exothermic reaction causes the blowing agent to evaporate or sublime, thereby releasing a gas. Alternatively, other thermal sources can be applied, including for example an external source of heat. The released gas can create a microcellular structure and displace an equivalent volume of the mix required to fill the mold cavity, producing a modified polymer matrix having a lower density and/or weight than an unmodified polymer matrix without a blowing agent. In some embodiments, this method does not require special equipment, allowing articles to be manufactured using a standard reaction injection molding process. FIGS. 7a-7c are micrographs showing exemplary embodiments of the closed cell polymer microstructures obtained when using a physical, liquid blowing agent. As was seen for the microstructures obtained using gas nucleation (FIGS. 6a-6b), the blowing agent derived microstructures (FIGS. 7a-7c) achieving 10%, 30% and 34% weight reduction exhibit a much lower density and greater void space than the standard polyurethane microstructure shown in FIG. 5.

In another exemplary embodiment, a chemical blowing agent, which creates gas bubbles via a chemical reaction, rather than evaporation or sublimation, can have the same or similar effect as a physical blowing agent on the microcellular structure of the polyurethane polymer matrix when mixed in with the polyurethane components. Typically, chemical blowing agents (e.g. water in polyurethane) form a gaseous by-product by reacting with the polyol, the isocyanate, and/or other material during the primary reaction between these two components. Also possible are chemical blowing agents which are themselves mixtures of two or more components, and which react separately from the polyol or isocyanate to form a gas.

Structures modified using gas nucleation or blowing agents exhibit different mechanical, thermal, and acoustic properties than unmodified structures of the same material. In seeking to maximize a particular property or group of properties, the optimum nucleation level for a given polyurethane system (chemistry) may be lower than what can be achieved. Moreover, the nature of the polymeric material can be adjusted as well. Different types of components in a polyurethane system can be utilized to adjust the nature of the polymer matrix to change, for example, the tackiness of the material or the amount of cros slinking in the polymer matrix.

In an embodiment, the reduction in amount can be greater than about 5%, greater than about 10%, greater than about 15%, greater than about 20%, greater than about 25% or greater than about 30%. The volume or weight reduction can be less than about 45%, less than about 40%, or less than about 35%. In an embodiment, the reduction can be between about 5% and about 45%, between about 10% and about 40%, between about 10% and about 35%, between about 15% and about 35%, between about 20% and about 35%, between about 25% and about 35%, or between about 20% and about 31%.

By way of example, early experiments determined that gas nucleation of about 5% in an early polyurethane system could create a product that passed test standards, but a product with gas nucleation of about 10% using the same polyurethane system failed to meet testing standards. However, increasing the amount of crosslinking present in the urethane material can produce a product that can meet testing standards using gas nucleation at 10%, 15%, 20%, 25% and 30%.

A comparison of physical and mechanical properties for a set of modified and unmodified groutless tile produced by various methods disclosed herein is provided in Table 2.

As Table 2 demonstrates, reductions in polymer weights and densities can be achieved while maintaining or improving other properties, e.g., strength, durability. Properties of a standard, groutless tile can be further tailored by choosing different base polymers for both methods. For example, the polymers can be formulated to have higher degree of crosslinks, which can result in other improved properties, as shown in Table 2.

TABLE 2

| | | Standard | Modified with | Modified with |
|---|---|---|---|---|
| | | Groutless | Gas nucleation | Blowing agent |
| Test Description | | Tile | method | method |
| Molded Polymer Weight | (g/sq. ft.) | 365 | 255 (30%) | 250 (31%) |
| (% Reduction) | | | | |
| Locking Mechanism | Shear (kg force) | 296 | 284 | 271 |
| Unit Mechanical Strength | Flexural Strength (kg force) | 227 | 274 | 217 |
| | Impact Resistance (dropped inches) | 10 | 13.2 | 13 |
| Robinson Floor Test | Wood Pier and Beam | Light | Light | Light |
| Rating | | Commercial | Commercial | Commercial |
| Thermal Cycling | Freeze-Thaw (−20 to 40 deg C.) | Pass | Pass | Pass |
| Polymer Thermal Expansion | CLTE (×10⁻⁶ length/length/deg C.) | 94 | 84 | 76 |
| | (30-60 deg C.) | | | |

One of ordinary skill in the art would also understand that testing standards, such as the one discussed above, will vary depending on the application the material is being used for. For example, a tile product for Light Commercial usage can have a different level of testing standards compared with, for example, a Residential Rating or Heavy Commercial. However, comparisons of product to product within the same standard can provide a qualitative assessment of the relative strengths of different products, in addition to the quantitative results of specific tests within each standard.

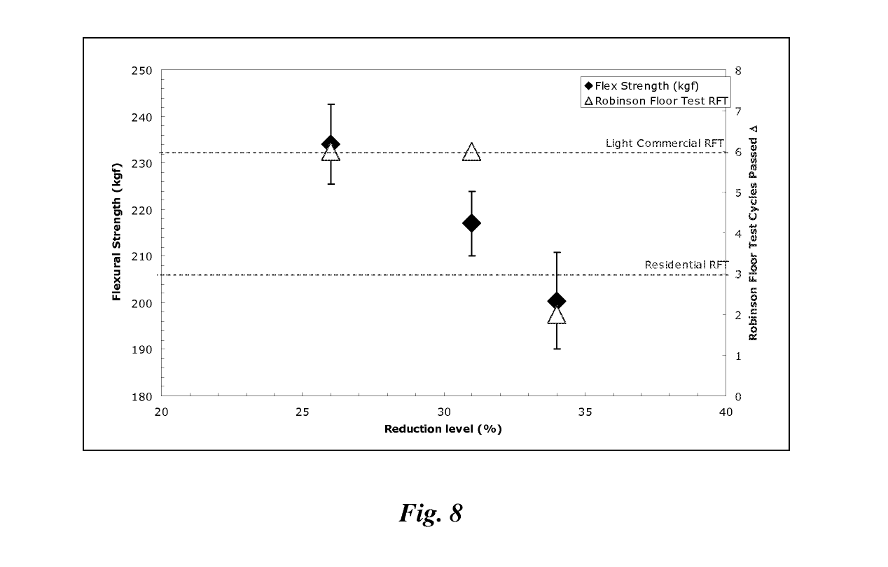

As mentioned previously, the best performing microcellular structure for a given application and polymer composition may not be at the maximum level of gas nucleation or blowing agent. Table 3 below provides information on the cell structure and polymer matrix density for the microcellular structures shown in FIGS. 5, 6 (a-b) and 7 (a-c). During testing of one crosslinked polyurethane, tiles with greater than a 31% reduction level showed a decrease in mechanical properties compared to tiles between 26% and 31%. FIG. 8 demonstrates a decrease in two properties of the tiles, flexural strength and Robinson floor test rating, for a range of reduction levels.

TABLE 3

| | Standard (no gas | Blowing agent, | Blowing agent, | Blowing agent, | Gas Nucleation | Gas Nucleation |
|---|---|---|---|---|---|---|
| | nucleation or | 10% wt | 30% wt | 34% wt | 10% wt | 10% wt |
| System | blowing agent | reduction | reduction | reduction | reduction | reduction |
| Average cell size | 67 | 66 | 54 | 37 | 88 | 109 |
| (microns) | | | | | | |
| Standard deviation | 10 | 15 | 9 | 4 | 22 | 24 |
| Number density of | 1.4 | 3 | 12 | 20 | 2.4 | 6 |
| cells | | | | | | |
| Part specific gravity | 1.05 | 0.92 | 0.78 | 0.67 | 0.92 | 0.82 |

As discussed previously, tile materials, such as but not limited to ceramic, stone, porcelain, wood, granite, quartz, marble, soapstone, plastic, and other natural or synthetic materials, are widely used as a floor and wall covering in both residential and commercial applications. Tile is very versatile, and has been in use as a floor and wall covering for centuries. Although tile is often a top choice for floor and wall coverings because of its great durability and aesthetic qualities, conventional tile can present some disadvantages. For example, some ceramic tiles are brittle, have sharp edges, and have strength issues depending on whether the tile is porcelain or vitreous. As another example, some natural tile materials can have variations in size and dimension due to, for example, errors in cutting of a stone material. An exemplary embodiment of the present invention is directed to overcoming one or more of these issues by the use of a composite groutless tile.

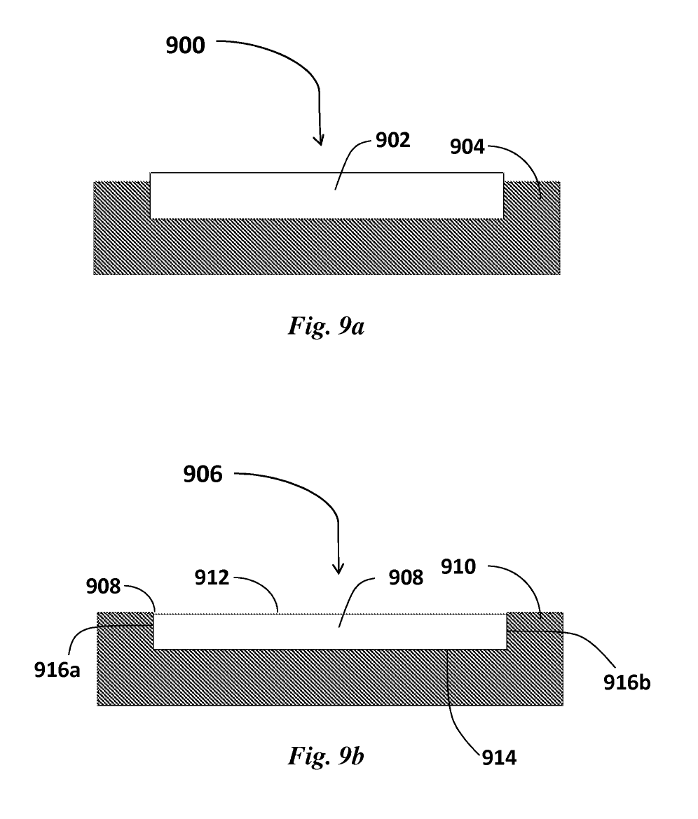

FIG. 9a illustrates an exemplary embodiment of the present invention wherein at least a portion of the tile is encapsulated to form composite groutless tile 900. Composite groutless tile 900 comprises tile 902, which can be ceramic, encapsulated in polymeric substrate 904. After substrate 904 hardens, substrate 904 can be milled to produce a tongue and groove interlocking profile for use with other encapsulated or unencapsulated groutless tiles. In some instances, it may be desirable to fully encapsulate a tile to cover at least a portion of the surface of the tile exposed to wear and tear. FIG. 9b illustrates fully encapsulated composite tile 906. Composite tile 906 comprises tile 908 and has multiple surfaces that can be encapsulated, including top surface 912, bottom surface 914 and, if tile 906 is rectangular, square or another shape having four sides, four side surfaces represented in part by side surface 916a and side surface 916b. It should be understood that tile 908 can have more than or less than four side surfaces depending on the particular shape of tile 908. For example, if tile 908 is a triangle, tile 908 will have three side surfaces. Tile 908 can be ceramic and, to form composite tile 906, is encapsulated in polymeric substrate 910. At least one of the side surfaces of tile 908 can be encapsulated partially or fully. In one exemplary embodiment of the present invention, side surface 916a is fully encapsulated by encapsulation portion 908 of substrate 910.

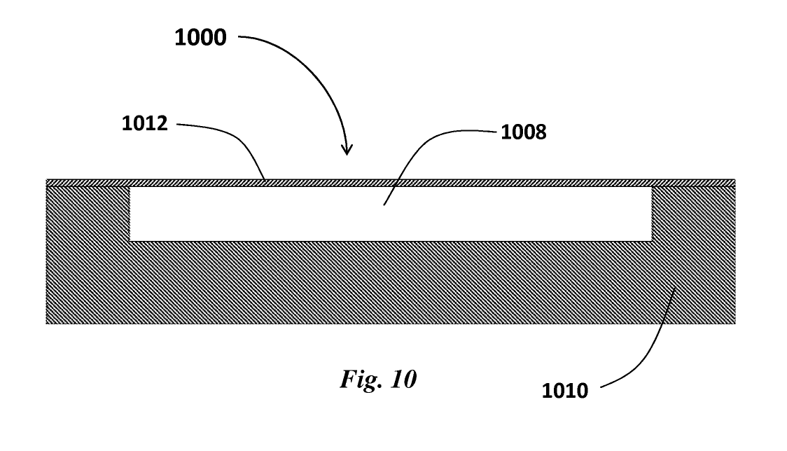

It may be desirable to encapsulate at least a portion of the top surface of a tile to form a composite tile. FIG. 10 is an illustration of an exemplary embodiment of the present invention. Composite tile 1000 comprising tile 1008 has additional encapsulation layer 1012 that covers at least a portion of the top surface of tile 1008. Encapsulation layer 1012 can be the same material as substrate 1010, and in fact, can be formed during the same processing step as substrate 1010 by providing a mold design that allows the polymer forming substrate 1010 to flow onto the surface of tile 1008, thus forming encapsulation layer 1012.

Encapsulation can be accomplished using various processing methods. In one embodiment, reaction injection molding or injection molding is used. Depending on the type of encapsulation process used, various types of polymers may be used. In the case of reaction injection molding, an exemplary polymer may be a thermosetting elastomeric polymer such as polyurethane. It should be understood that the present invention is not limited to a thermosetting elastomeric polymer polyurethane, as other types of polymers and other types of thermosetting elastomeric polymers can be used, including, for example, thermosetting polymers. The choice of polymer is dictated by the method of fabrication and the tile's end use properties. For example, in a direct molding method the polymer preferably has very good bonding properties to ceramic tile and can be disposed directly on the tile to allow stress transfer between the tile and the polymer component. In other examples, adhesives may be used.

When using polyurethane, the reacting components are mixed: isocyanate and polyol resin. The two components are mixed at high pressure and molded on to a ceramic tile, which is facing down in the mold. After a sufficient cure period, the cured, encapsulated tile is removed, resulting in a composite tile. The molded polymer component provides for a relatively strong mechanical bond and clamps the tile on all sides. There are numerous other benefits that may be observed when using composite tile manufactured according to various embodiments of the present invention. A composite tile may exhibit higher breaking strength. Adding the polymer component provides a stress transfer mechanism that results in improved breaking strength. A composite material may produce a more uniform commercial product because the polymer component can have a consistent shape and dimension as compared to a natural tile material.

Also, a composite tile may delay crack propagation. The polymer component clamps the ceramic tile mechanically, which serves as a temporary crack arresting mechanism and can delay fracture following crack initiation. Also, a composite tile can have higher impact resistance. The polymer component can absorb and dissipate the energy of an impact, making the composite tile less likely to break upon impact with objects or if dropped prior to installation. Also, the composite tile can exhibit greater flexural strength and can reduce the chance of a sharp edge being present that can cut or lacerate an individual. Further, the composite tile can exhibit improved thermal insulation properties over conventional tile because of the low thermal conductivity of the polymer component.

Table 4, below, shows the mechanical properties of an exemplary composite ceramic tile manufactured in accordance with various embodiments of the present invention. The composite tiles were measured by standard test methods and the results were compared to non-composite ceramic tile.

TABLE 4

| | Breaking strength(lbf) | | | |
|---|---|---|---|---|
| | ASTM C648-94 | | Impact to | Flexural |
| | Crack | | steel ball | Strength |
| Tile | initiated | Fracture | Average height | (lbf) |
| Unmolded porcelain | 340.0 | 340.0 | 4.0 | 418.0 |
| tile | | | | |
| Unmolded porcelain | 341.0 | 341.0 | 5.9 | 402.6 |
| tile | | | | |
| Composite tile with | 438.0 | 945.0 | 10.0 | 528.0 |
| full density | | | | |
| polyurethane | | | | |
| Composite tile, 30% | 424.0 | 843.0 | 14.5 | 486.2 |
| wt reduction, blowing | | | | |
| agent | | | | |

While the exemplary embodiments of the invention have been described, it will be understood that those skilled in the art, both now and in the future, may make various improvements and enhancements, which fall within the scope of the claims that follow. These claims should be construed to maintain the proper protection for the invention first described.

What is claimed is:

1. A groutless tile comprising:
a substrate comprising a modified polymer matrix comprising a first polymer, wherein the modified polymer matrix comprises a reduced amount of the first polymer per unit volume of substrate than an unmodified polymer matrix;
a durable surface disposed on the substrate; and
a first coupling member disposed on an edge of the substrate.

2. The groutless tile of claim 1, wherein the first polymer is polyurethane.

3. The groutless tile of claim 1, wherein the modified polymer matrix comprises a second polymer of lower weight or cost than the first polymer

4. The groutless tile of claim 1, wherein the amount of modified polymer matrix is reduced by about 10% to about 40% compared to the unmodified polymer matrix.

5. The groutless tile of claim 1, wherein the amount of modified polymer matrix is reduced by about 20% to about 35% compared to the unmodified polymer matrix.

6. The groutless tile of claim 1, wherein the amount of modified polymer matrix is reduced by about 25% to about 35% compared to the unmodified polymer matrix.

7. The groutless tile of claim 1, wherein the modified polymer matrix is modified by the process of gas nucleation.

8. The groutless tile of claim 7, wherein a gas used for gas nucleation is argon, carbon dioxide or nitrogen.

9. The groutless tile of claim 1, wherein the modified polymer matrix is modified by a blowing agent.

10. The groutless tile of claim 9, wherein the blowing agent is hydrohalocarbon.

11. The groutless tile of claim 1, wherein the durable surface is further disposed within a groove defined by the substrate, the durable surface having bottom surface.

12. The groutless tile of claim 1, wherein:
the first coupling member comprises a first bendable portion and a groove, the groove having an upper surface and a lower surface; and
the bottom surface of the durable surface is substantially coplanar with a point between the upper and lower surfaces of the groove.

13. The groutless tile of claim 1, wherein at least a portion of the substrate extends beyond the durable surface.

14. The groutless tile of claim 13, wherein the first coupling member and a second coupling member of an adjacent groutless tile comprising a tongue and a body portion are operable for coupling adjacent groutless tiles.

15. The groutless tile of claim 14, wherein the tongue is located at a distal end of the second coupling member and extends outwardly and substantially horizontally from an edge of a substrate of the adjacent groutless tile.

16. The groutless tile of claim 15, wherein the groove of the first coupling member is configured to receive the body portion and the tongue of the second coupling member.

17. The groutless tile of claim 16, wherein, upon coupling the adjacent tiles, the tongue and the groove engage under the portion of the substrate that extends beyond the durable surface.

18. The groutless tile of claim 17, wherein, upon coupling of the adjacent tiles, a gap remains between a distal end of the tongue and a proximal end of the groove.

19. The groutless tile of claim 18, wherein, upon coupling the adjacent tiles, a contact surface between the tongue and the groove is formed at a top side of the tongue, such that the contact surface limits vertical motion of the coupled adjacent tiles.

20. The groutless tile of claim 19, wherein at least a portion of the first bendable portion is disposed below the durable surface of the adjacent tile when coupled to the adjacent tile.

21. The groutless tile of claim 1, wherein the first coupling member, the durable surface, and the second coupling member of the groutless tile form a continuous surface.

22. The groutless tile of claim 1, wherein at least a portion of the substrate is designed to have a texture and color similar to that of grout.

23. The groutless tile of claim 1, wherein the durable surface is partially encapsulated in the substrate thru the RIM process.

24. The groutless tile of claim 1, wherein the plurality of groutless tiles further comprise a layment layer disposed on a surface of the substrate opposite of the durable surface.

25. The groutless tile of claim 1, wherein a lateral force is used to couple the first coupling member and the second coupling member of an adjacent tile.

26. A method of manufacturing a groutless tile system comprising:
providing a durable surface:
inserting and positioning the durable surface into a mold;
forming a substrate comprising a first polymer and a second component around at least a portion of the durable surface to create a groutless tile, wherein the second component reduces by about 10% to about 40% the amount of the first polymer in the substrate, wherein at least a portion of the substrate extends beyond the durable surface; and
producing a first coupling member and a second coupling member by removing at least a portion of the substrate material, wherein the first coupling member comprises a first bendable portion and a groove.

27. The method of claim 26, wherein forming a substrate comprises injection molding or reaction injection molding.

28. The method of claim 26, wherein the second component is a blowing agent or an inert gas.

29. The method of claim 26, wherein:
the durable surface is disposed within a groove defined by the substrate, the durable surface having bottom surface;
the groove comprises an upper surface and a lower surface;
the second coupling member comprises a tongue and a body portion; and
the bottom surface of the durable surface is substantially coplanar with a point between the upper and lower surfaces of the groove.

30. The method of claim 26, wherein the first coupling member and the second coupling are operable for coupling adjacent groutless tiles.

31. A groutless tile system, comprising:
a plurality of groutless tiles, wherein each groutless tile comprises:
a substrate comprised of a polymer matrix comprising a first polymer, wherein the polymer matrix is modified to reduce the amount of first polymer used for unit volume of the polymer matrix;
a durable surface disposed within a groove defined by the substrate; and
a first coupling member disposed on an edge of the substrate, wherein the first coupling member comprises a first bendable portion and a groove;
wherein at least a portion of the substrate extends beyond the durable surface;
wherein the first coupling member and a second coupling member of an adjacent groutless tile comprising a tongue and a body portion are operable for coupling adjacent groutless tiles;
wherein the tongue is located at a distal end of the second coupling member and extends outwardly and substantially horizontally from an edge of a substrate of the adjacent groutless tile;
wherein the groove of the first coupling member is configured to receive the body portion and the tongue of the second coupling member;
wherein, upon coupling the adjacent tiles, the tongue and the groove engage under the portion of the substrate that extends beyond the durable surface;
wherein, upon coupling of the adjacent tiles, a gap remains between a distal end of the tongue and a proximal end of the groove;
wherein, upon coupling of the adjacent tiles, a contact surface between the tongue and the groove is formed at a top side of the tongue, such that the contact surface limits vertical motion of the coupled adjacent tiles; and
wherein at least a portion of the first bendable portion is disposed below the durable surface of the adjacent tile when coupled to the adjacent tile.
